(19) United States
(12) Patent Application Publication
(10) Pub. No.: US 2016/0189273 A1
(43) Pub. Date: Jun. 30, 2016

(54) EVENT AND LOCATION BASED RECOMMENDATIONS

(71) Applicant: DAVID ERAMIAN, Mountain View, CA (US)

(72) Inventor: DAVID ERAMIAN, Mountain View, CA (US)

(21) Appl. No.: 14/585,831

(22) Filed: Dec. 30, 2014

(51) Int. Cl. G06Q 30/06; H04W 4/02

(52) U.S. Cl. CPC G06Q 30/0631; H04W 4/02

(57) ABSTRACT

Systems and methods are presented for generating and causing presentation of recommendations of one or more portable articles suitable for a desired location. In some embodiments, the system receives a set of identification data from a set of portable articles and a set of location data indicative of a set of locations corresponding to one or more portable articles of the set of portable articles. The system generates a set of associations between the set of identification data and the set of location data. The system receives a desired location of the set of locations. The system generates a recommendation of one or more recommended portable articles from the set of portable articles and causes presentation of the recommendation on a user interface of a user device.

### TECHNICAL FIELD

The subject matter disclosed herein generally relates to the processing of data. Specifically, the present disclosure addresses systems and methods to generate recommendations based on events and locations.

### BACKGROUND

People rely on word of mouth, knowledge of a location or event, anonymous internet sources, and guessing to determine what to wear or what things to bring when doing a new activity, visiting a new place, meeting new people, or starting a new job. People attending an activity, event, or location for the first time may be at a loss as to what other activities, related or unrelated, may be available based on their current location, plans, or clothing. Determining what to do in a new place, what to do given time around a predetermined event, and what to wear or bring for activities can be daunting and involve expending a great deal of effort. Currently an individual may search myriad different sources to determine activities and dress codes for locations and additional sources to determine whether clothing or accoutrements they currently have would be appropriate for the activities and dress codes they have identified.

### BRIEF DESCRIPTION OF THE DRAWINGS

Some embodiments are illustrated by way of example and not limitation in the figures of the accompanying drawings.

FIG. 1 is a network diagram illustrating a network environment suitable for generating and causing presentation of recommendations of one or more portable articles suitable for a desired location, according to some example embodiments.

FIG. 2 is a block diagram illustrating components of a server machine, according to some example embodiments.

FIG. 3 is a flowchart illustrating operations of a server machine, according to some example embodiments, performing a method of generating recommendations of one or more portable articles suitable for a desired location.

FIG. 4 is a flowchart illustrating operations of a server machine, according to some example embodiments, performing a method of determining a purchasable portable article corresponding to a recommendation of one or more portable articles suitable for a desired location.

FIG. 5 is a flowchart illustrating operations of a server machine, according to some example embodiments, performing a method of generating a recommendation of one or more portable articles suitable for a desired location, from a set of portable articles in possession of a user.

FIG. 6 is a flowchart illustrating operations of a server machine, according to some example embodiments, performing a method of determining a purchasable portable article suitable for a desired location, corresponding to a recommended portable article not included in a set of portable articles in possession of a user.

FIG. 7 is a flowchart illustrating operations of a server machine, according to some example embodiments, performing a method of generating recommendations of one or more portable articles suitable for a desired location.

FIG. 8 is a block diagram illustrating components of a machine, according to some example embodiments, able to read instructions from a machine-readable medium and perform any one or more of the methodologies discussed herein.

FIG. 9 is a block diagram illustrating components of a mobile device, according to some example embodiments, able to read instructions from a machine-readable medium and perform any one or more of the methodologies discussed herein.

### DETAILED DESCRIPTION

Example methods and systems are directed to generating and causing presentation of recommendations of portable articles based on locations, times, events, and portable articles previously used in relation to those locations, times, and events. For example, the methods and systems disclosed herein can enable a user to determine what clothing to wear and what equipment or accessories to bring to a location or event based on the detection of clothing and accessories other individuals have worn or used at the same or similar locations and events. In some instances, a user can determine what to wear to a restaurant, club, new workplace, or other similar experiences, locations, and events. Clothing, equipment, and accessories (e.g., portable articles) can contain identification transceivers (e.g., radio frequency identification (RFID) chips) that can communicate with a smartphone, wearable computing device, or other device. The clothing, equipment, and accessories can communicate with these devices so that the devices or a system in communication with the devices knows what the user is wearing or has brought to a location or event. The smartphone or other communications device can communicate its location, and information about the articles communicating with the communications device, to a central system. The clothing data (e.g., identification and location data) can be presented to other users who want to know what types of clothing, equipment, and accessories to wear or bring to a particular location or event. The clothing data is anonymous (e.g., stripped of personal identifying information) and encrypted prior to storage and use by the system.

Systems and methods can also enable the user to receive recommendations for additional locations or events to attend based on the event or location they are attending, the clothing or accessories they currently have, times of day, or combinations thereof. For example, if a user is booking tickets for a theater event, the central system can generate a recommendation and book or reserve any applicable available spaces for a dinner prior to the theater event. The central system can also recommend clothing and accessories that match styles and suitable dress for the recommended locations. In some instances, the central system can make recommendations from a user's wardrobe or from stores from which the user may purchase appropriate clothing, equipment, or accessories. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

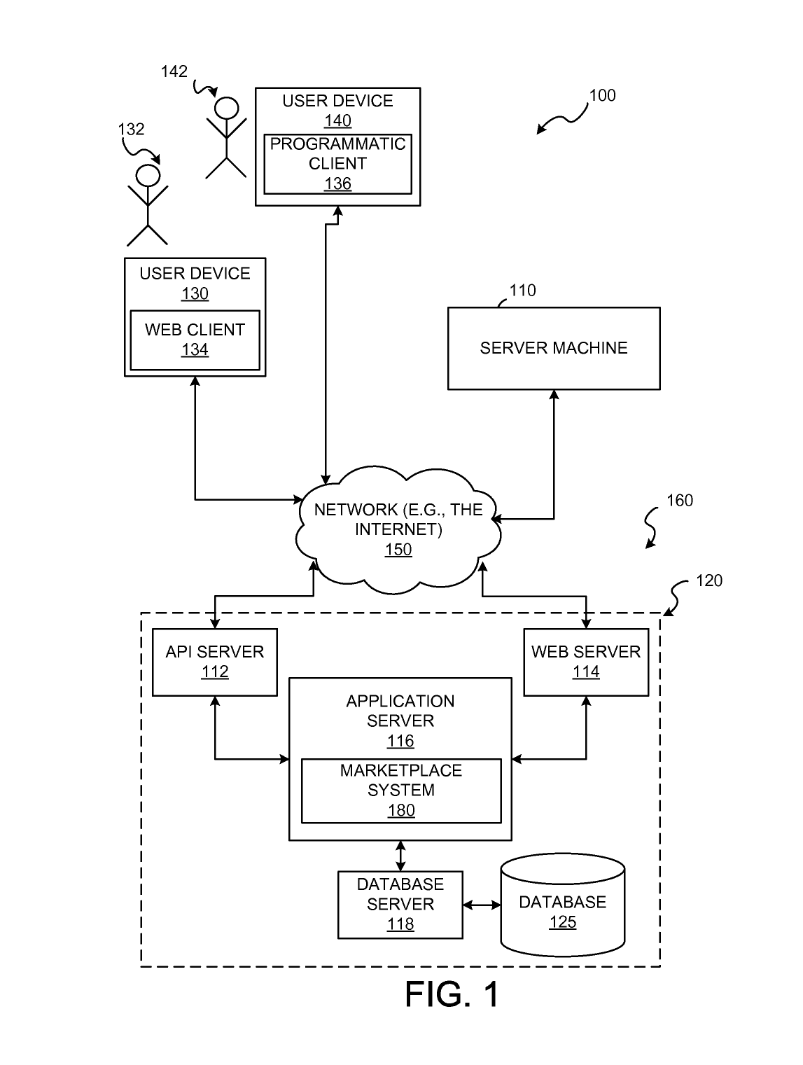

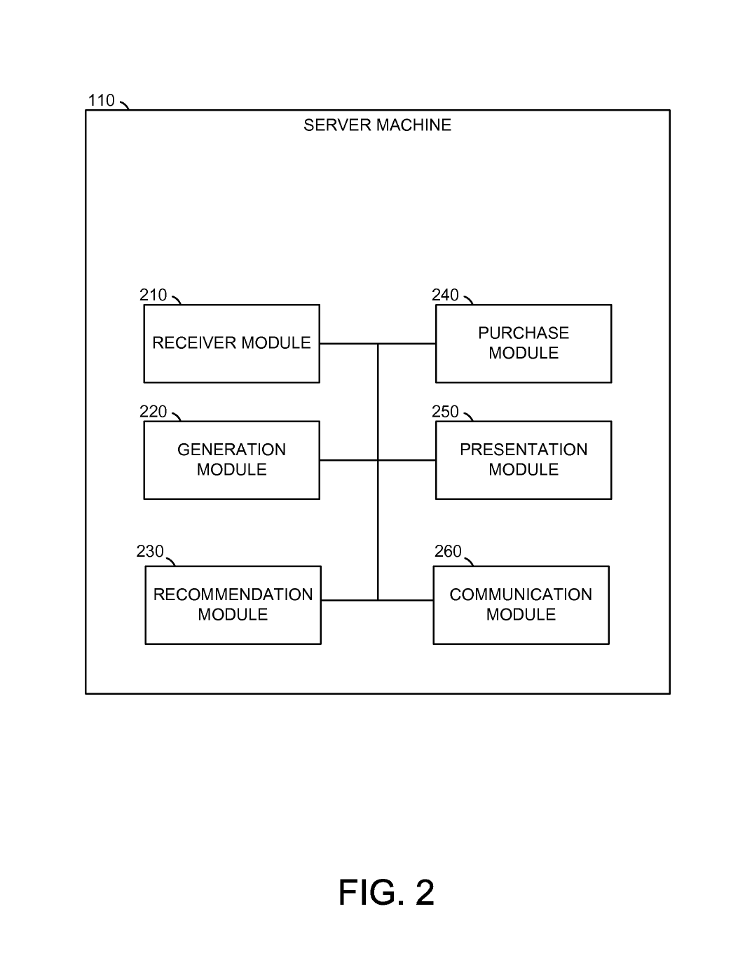

FIG. 1 is a network diagram illustrating a network environment 100 suitable for generating and causing presentation of recommendations of one or more portable articles suitable for a desired location, according to some example embodiments. The network environment 100 includes a server machine 110, a publication system 120, and user devices 130 or 140, all communicatively coupled to each other via a network 150. The server machine 110, explained in more detail with reference to FIG. 2, can form a part of a network-based system configured to generate and cause presentation of recommendations of one or more portable articles suitable for a desired location.

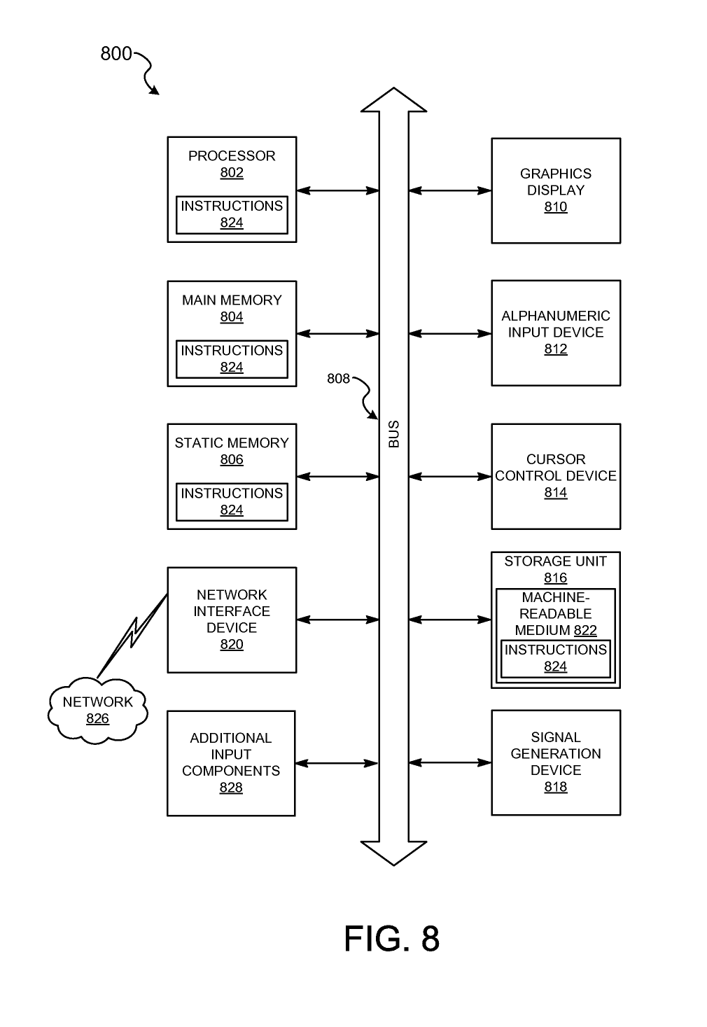

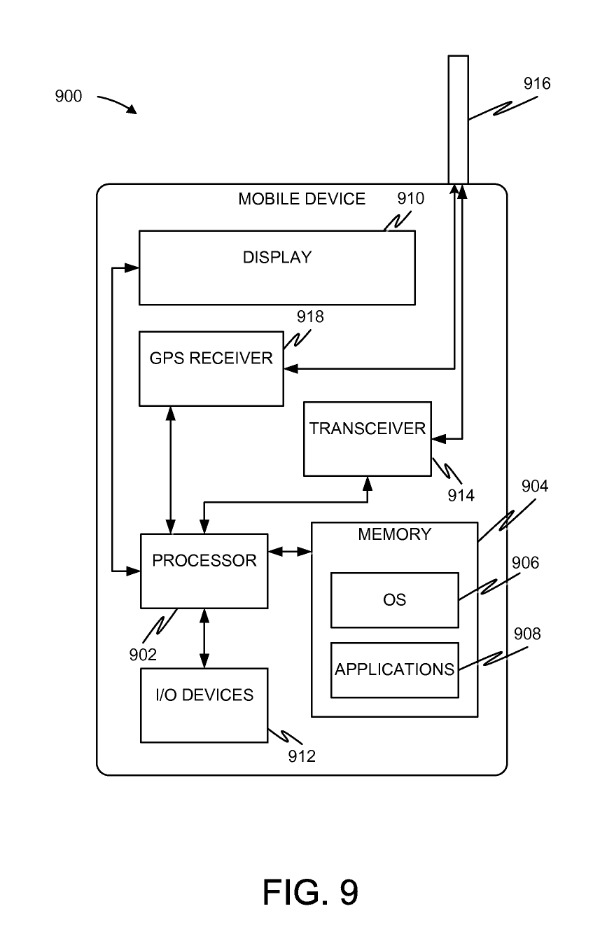

The publication system 120 is shown as including an application programming interface (API) server 112, a web server 114, an application server 116, a database server 118, and a database 125. In some embodiments, the publication system 120 forms all or part of a network-based system 160 (e.g., a cloud-based server system configured to provide one or more services to the user devices 130 and 140). The server machine 110, the publication system 120, and the user devices 130 and 140 may each be implemented in a computer system, in whole or in part, as described below with respect to FIG. 8. In some embodiments, the user devices 130 and 140 can be implemented in a mobile device, as described below with respect to FIG. 9.

The API server 112 provides a programmatic interface by which the user devices 130 and 140 can access the publication system 120. The API server 112 can be a machine similar to that described with respect to FIG. 8, and can be implemented as a single API server 112 or a plurality of API servers 112. The API server 112 can contain software, processor-executable instructions, or modules (containing one or more of software and hardware) enabling the API server 112 to provide the programmatic interface between the user devices 130 and 140 and the publication system 120.

The application server 116 may be implemented as a single application server 116 or a plurality of application servers 116. The application server 116, as shown, hosts one or more marketplace systems 180, which comprise one or more modules or applications and which may be embodied as hardware, software, firmware, or any combination thereof. The application server 116 is, in turn, shown to be coupled to the database server 118, which facilitates access to one or more information storage repositories or databases, such as the database 125.

The marketplace system 180 provides a number of marketplace functions and services to users who interface with the network-based system 160. For example, the marketplace system 180 can provide information for products for sale or at auction facilitated by the marketplace system 180 and displayable on the user devices 130 and 140. In some embodiments, the marketplace system 180 provides listings for products indicative of the information for products. The listings for products can be stored in the database 125 and may be searchable through the network-based system 160. The listings may include information indicative of a product, a condition of the product, terms of sale for the product, shipping information, a description of the product, a quantity, a purchase price of the product, a best offer option (i.e., an indication that a seller is willing to negotiate for a price below that of a listed purchase price), a reserve price, a current auction price, metadata associated with the product, metadata associated with coding for the listing, a bidding history, and a best offer history (e.g., negotiation history containing offers and counter offers and parties associated with the offers and counter offers), and information indicative of product organization, such as titles, categories, category taxonomies, and product interrelations. The marketplace system 180 can also facilitate the purchase of products in an online marketplace that can later be delivered to buyers via shipping or any conventional method.

While the marketplace system 180 is shown in FIG. 1 to form a part of the network-based system 160, it will be appreciated that, in some embodiments, the marketplace system 180 may form part of a payment service that is separate and distinct from the network-based system 160. Further, while the client-server-based network environment 100 shown in FIG. 1 employs a client-server architecture, the present disclosure is not limited to such an architecture, and may equally well find application in a distributed architecture system (e.g., peer-to-peer), for example. The various marketplace systems 180 may also be implemented as standalone software programs, which do not necessarily have networking capabilities. In some embodiments, the marketplace system 180 may form part of a payment service that is a part of the network-based system 160.

The database server 118 is coupled to the database 125 and provides access to the database 125 for the user devices 130 and 140 and other aspects of the server machine 110. The database 125 can be a storage device that stores information related to products; documents; web sites; metadata relating to products, documents, or websites; and the like.

Also shown in FIG. 1 are users 132 and 142. One or both of the users 132 and 142 can be a human user (e.g., a human being), a machine user (e.g., a computer configured by a software program to interact with the user devices 130 and 140), or any suitable combination thereof (e.g., a human assisted by a machine or a machine supervised by a human). The user 132 is not part of the network environment 100, but is associated with the user device 130 and is a user of the user device 130. For example, the user device 130 can be a desktop computer, a vehicle computer, a tablet computer, a navigational device, a portable media device, a smartphone, or a wearable device (e.g., a smart watch or smart glasses) belonging to the user 132. Likewise, the user 142 is not part of the network environment 100, but is associated with the user device 140. As an example, the user device 140 can be a desktop computer, a vehicle computer, a tablet computer, a navigational device, a portable media device, a smartphone, or a wearable device (e.g., a smart watch or smart glasses) belonging to the user 142.

The user device 130 contains a web client 134 which may access the various marketplace systems 180 and, in some cases, the server machine 110, via the web interface supported by the web server 114. Similarly, the user device 140 contains a programmatic client 136 configured to access the various services and functions provided by the marketplace system 180 and, in some cases, the server machine 110, via the programmatic interface provided by the API server 112. The programmatic client 136 may, for example, perform batch-mode communications between the programmatic client 136 and the network-based system 160 and the server machine 110.

Any of the machines, databases 125, or devices shown in FIG. 1 may be implemented in a general-purpose computer modified (e.g., configured or programmed) by software (e.g., one or more software modules) to be a special-purpose computer to perform one or more of the functions described herein for that machine, database 125, or device. For example, a computer system able to implement any one or more of the methodologies described herein is discussed below with respect to FIGS. 8 and 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 125, or devices illustrated in FIG. 1 may be combined into a single machine, database, or device, and the functions described herein for any single machine, database 125, or device may be subdivided among multiple machines, databases 125, or devices.

The network 150 may be any network that enables communication between or among machines, databases 125, and devices (e.g., the server machine 110 and the user device 130). Accordingly, the network 150 can be a wired network, a wireless network (e.g., a mobile or cellular network), or any suitable combination thereof. The network 150 can include one or more portions that constitute a private network, a public network (e.g., the Internet), or any suitable combination thereof. Accordingly, the network 150 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 150 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

FIG. 2 is a block diagram illustrating components of the server machine 110, according to some example embodiments. The server machine 110 is shown as including a receiver module 210, a generation module 220, a recommendation module 230, a purchase module 240, a presentation module 250, and a communication module 260, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database 125, or device may be distributed across multiple machines, databases 125, or devices.

The receiver module 210 receives a set of identification data from a set of portable articles, a set of location data indicative of a set of locations corresponding to one or more portable articles of the set of portable articles, and a desired location. The receiver module 210 can also receive a set of time data. The time data can be representative of a time at which one or more portable articles were proximate to a location of the set of locations. The time data can also indicate a time duration during which the one or more portable articles were located at the location. The receiver module 210 can be a hardware implemented module, a software implemented module, or a combination thereof. An example embodiment of components of the receiver module 210 is described with respect to the modules discussed in further detail below.

The receiver module 210 can receive the identification data from identification transceivers (e.g., RFID tag, global positioning system (GPS) tag, Bluetooth® device) connected to each portable article of the set of portable articles. In some instances, the receiver module 210 can receive the location data from the identification transceiver. The receiver module 210 can also receive the location data from a communication device proximate to the portable article present at the location, where the communication device receives the identification data from the identification transceiver associated with the portable article. For example, where the identification transceiver is an RFID tag, a communication device (e.g., the user device 130) can receive the identification data from the identification transceiver and transmit the identification data and the location data to the receiver module 210. The receiver module 210 can receive the time data from the identification transceiver or the communication device. In some instances, the receiver module 210 can receive the time data by identifying a time at which the receiver module 210 receives the identification data and the location data for the portable article.

The generation module 220 generates a set of associations between the set of identification data and the set of location data. An association of the set of associations is a portable article profile associating one or more portable articles of the set of portable articles with a location of the set of locations. For example, the generation module 220 can interact with a database (e.g., the database 125), a data structure (e.g., a data table, an array, a linked list), a website, a cloud storage, a webserver, or another suitable storage medium or data structure capable of receiving data indicative of the set of associations. The generation module 220, interacting with the storage medium or data structure, can generate the set of associations by generating or modifying data representative of the set of identification data and the set of location data, metadata associated with one or more of the set of identification data and the set of location data, and one or more data structures or file structures to generate the set of associations, or by any other suitable method. The generation module 220 can be a hardware implemented module, a software implemented module, or a combination thereof, as described in more detail below.

The recommendation module 230 generates a recommendation of one or more recommended portable articles from the set of portable articles based on the portable article profile for the desired location. For example, where the desired location is a location of the set of locations, the recommendation can include one or more of the portable articles within the portable article profile associated with the desired location. Where the desired location is not a location of the set of locations, the recommendation module 230 can determine a correspondence of the desired location with one or more locations of the set of locations. In these embodiments, the recommendation module 230 can include one or more of the portable articles within the portable article profile for each of the one or more locations. In some instances, a subset of the portable articles within the recommendation can be associated with a predetermined season, time of year, time of day, event, or event type. In these instances, the recommendation module 230 can further base the recommendation on time data, season, event data, event type, or any other appropriate characteristic to generate a recommendation appropriate for the desired location, time of year, time of day, selected event, or selected event type. The recommendation module 230 can be a hardware implemented module, a software implemented module, or a combination thereof, as described below.

The purchase module 240 accesses a set of purchasable portable articles and determine a purchasable portable article from the set of purchasable portable articles corresponding to the one or more recommended portable articles. For example, the purchase module 240 can access the set of purchasable portable articles within the database 125 of the publication system 120. In this example, the publication system 120 can be an electronic commerce website, an auction website, a social media publication website, a product catalogue accessible by the publication system 120, or the like. The purchase module 240 can be a portion of the publication system 120 or be in communication with the publication system 120 via the communication module 260. The purchase module 240 can be a hardware module, a software module, or a combination thereof. For example, the purchase module 240 can be implemented similarly to the modules described below.

The presentation module 250 causes presentation of the recommendation on the user interface of the user device 130. For example, the presentation module 250 can generate one or more user interface elements, screens, web pages, or the like, presenting the recommendation on the user interface of the user device 130. In some embodiments, the presentation module 250 can cause presentation of the recommendation by transmitting data indicative of the recommendation to the user device 130. In some instances, a portion of the presentation module 250 can be implemented by the user device 130 (e.g., a portion of an application running on the user device 130) to cause presentation of the recommendation on the user interface. The presentation module 250 can be a hardware implemented module, a software implemented module, or a combination thereof, as described in more detail below.

The communication module 260 enables communication between the user device 130, the server machine 110, the identification transceiver connected to a portable article of the set of portable articles, the publication system 120, and one or more external systems (e.g., a social media site). In some example embodiments, the communication module 260 can enable communication among the receiver module 210, the generation module 220, the recommendation module 230, the purchase module 240, and the presentation module 250. The communication module 260 can be a hardware implemented module, a software implemented module, or a combination thereof, as described in more detail below. For example, the communication module 260 can include communications mechanisms such as an antenna, a transmitter, one or more busses, and other suitable communication mechanisms capable of enabling communication between the modules 210-250, the user device 130, the server machine 110, and the identification transceiver connected to a portable article of the set of portable articles.

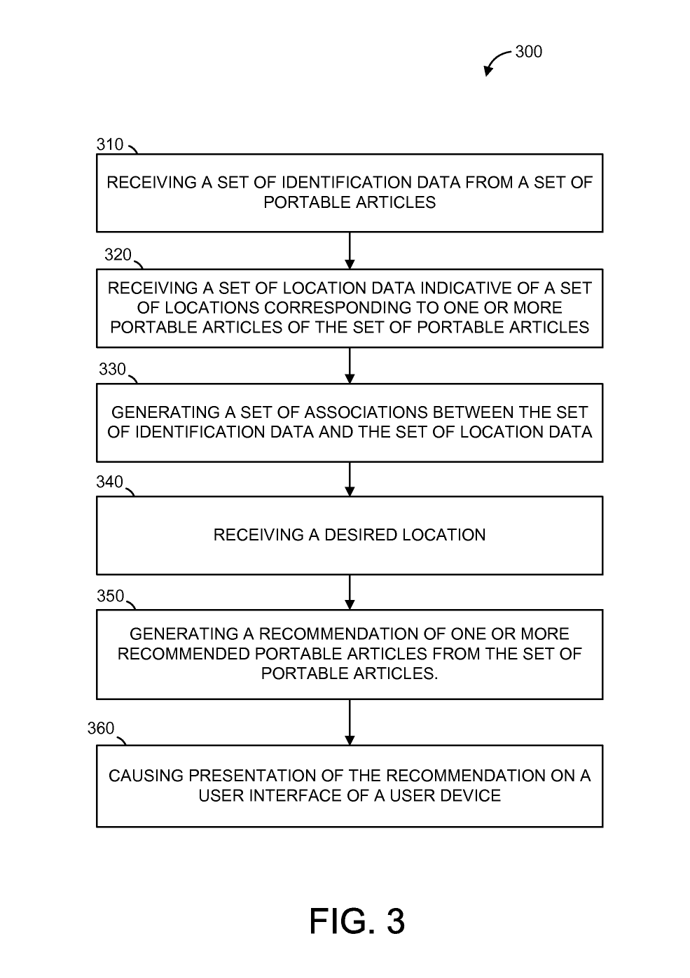

FIG. 3 is a flowchart illustrating operations of the server machine 110 in performing a method 300 of generating recommendations of one or more portable articles suitable for a desired location. Operations in the method 300 may be performed by the server machine 110, using modules described above with respect to FIG. 2. In some embodiments, the operations of the method 300 can be performed using the modules of FIG. 2, where portions of the modules may be implemented on user devices such as the user device 130.

In operation 310, the receiver module 210 receives a set of identification data from a set of portable articles. The set of portable articles can include or be selected from a group consisting of a set of clothing, a set of clothing accessories, a set of fashion accessories, and a set of portable equipment. For example, portable articles can be wearable articles such as articles of clothing, watches, shoes, hats, hair accessories, glasses, coats, or other wearable articles. Portable equipment of the set of portable equipment can include backpacks, camping gear, tents, chairs, tables, sports equipment, electronics equipment (e.g., digital cameras, video cameras, audio playback devices, and speakers), boating equipment, and other portable equipment suitable to a location or one or more events occurring at a location.

The identification data can include any suitable information identifying portable articles of the set of portable articles. For example, where the identification data is representative of an article of clothing, the identification data can include a clothing gender (e.g., men's clothing, women's clothing), an age range (e.g., 12M-5T, children's clothing, teen's clothing, adult clothing), type of clothing (e.g., pants, jacket, shirt, button up shirt, oxford shirt, jeans, skirt, boots, tennis shoes, dress shoes, high heels, sandals), brand of clothing, color of clothing, and other identifying characteristics. By way of another example, where the identification data is representative of portable equipment, such as a tent, the identification data can include a manufacturer, a tent type (e.g., four season, three season, floorless, Bivy, bug netting, dome, ridge, geodesic, tunnel, yurt), a tent color, a size (e.g., occupancy rating, square foot measurements, cubic foot measurements), construction material (e.g., canvas, nylon), features (e.g., door type, rainfly, ventilation, vestibule, interior loops, pockets, Guyout loops), and other identifying characteristics. As is apparent from the examples, the identification data can vary depending on the portable article. As such, data structures (e.g., tables, arrays, objects) in which the identification data can be stored may vary in size, structure, format, number of data fields, and data types, to accommodate variations in representing the identifying characteristics included in the identification data.

In some embodiments, prior to being received by the receiver module 310, the identification data is sanitized of personal information relating to a user associated with the portable article, thereby generating anonymous identification data. For example, the identification data can be stripped of personal information prior to being received by the receiver module 210. In some embodiments, after being received by the receiver module 210, the identification data is sanitized of personal information relating to a user associated with the portable article. In these embodiments, the personal information (e.g., a name, account information, a user profile identification, etc.) is stripped from the identification data by the generation module 220. In some example embodiments, after being sanitized (e.g., made anonymous by stripping personal information), the identification data is encrypted. For example, the identification data can be encrypted prior to transmission to the receiver module 210. However, in some instances, the identification data is encrypted prior to being sanitized, for example, where the identification data is stripped of personal information after being received by the receiver module 210. In some embodiments, after being received by the receiver module 210, the generation module 220 can encrypt the identification information and store the encrypted identification information on a database for further use, as described in method 300.

The identification data can be received from identification transceivers associated with a portable article. For example, where a portable article is an article of clothing, the article of clothing may have an identification transceiver connected thereto in the form of an RFID tag. In this instance, the RFID tag can contain the identification data including data representative of identifying characteristics of the article of clothing. The identification information can be read by a reader (e.g., user device 130 or another suitable device) through radio transmissions from the RFID tag and can be powered for transmission by radio waves or electromagnetic induction from the reader or another device. In these embodiments, the reader can then transmit the identification data to the receiver module 210. In other embodiments, the identification transceiver can be a GPS transceiver, a Bluetooth® device, a barcode reader (e.g., reading a barcode containing the identification data associated with the portable article), a near field communication (NFC) device, or any other device capable of containing the identification data and transmitting or otherwise causing the identification data to be received by the receiver module 210.

In operation 320, the receiver module 210 receives a set of location data indicative of a set of locations corresponding to one or more portable articles of the set of portable articles. The receiver module 210 can receive the set of location data via the network 150. In some instances, the receiver module 210 can receive the location data from the identification transceiver. For example, in embodiments where the identification transceiver is a GPS device or a Bluetooth® device capable of determining a location, the identification transceiver can determine the location of a portable article at a given time and for a given time duration and transmit one or more of the location, the time, and the time duration to be received by the receiver module 210. In instances where the receiver module 210 receives the identification data from the identification transceiver via the user device 130 or another communications device, the user device 130 or other communications device receiving the identification data can determine the location at a time proximate to receiving the identification data and transmit the location data to be received by the receiver module 210. In some embodiments, where the identification transceiver and the communications device transmitting the identification data cannot determine a location, the location data is determined by a predetermined location associated with the communications device (e.g., a communications device installed at a restaurant and including information directed to the installation location). Here, the communications device can be a cell tower, a WIFI router at a business, or similar communications device having a predetermined and known location.

In operation 330, the generation module 220 generates a set of associations between the set of identification data and the set of location data. An association of the set of associations can form a portion of a portable article profile associating one or more portable articles of the set of portable articles with a location of the set of locations. The generation module 220 can generate the associations by modifying a portion of the identification data or a portion of the location data. In some embodiments, the generation module 220 can generate the set of associations by generating or modifying metadata associated with one or more of the set of identification data and the set of location data. For example, the generation module 220 can generate a metadata file for the set of associations having an array or a table having values indicative of each of the locations of the set of locations and each of the portable articles of the set of portable articles. The values entered into the array or table may then indicate an association between locations of the set of locations and one or more portable articles of the set of portable articles. By way of further example, a portable article profile, representative of an association, can include a single location with four portable articles (e.g., shirt, pants, shoes, and wristwatch), where the four portable articles represent an outfit worn by an individual while visiting the location of the portable article profile.

In operation 340, the receiver module 210 receives a desired location. The desired location may be a location of the set of locations. In some instances, the desired location may not be included among the set of locations. Where the desired location is not included among the set of locations, the receiver module 210 can pass the desired location (e.g., data representative of a selection of the desired location within the user interface of the user device 130) to the recommendation module 230. As will be discussed below, the recommendation module 230 can determine a correspondence between the desired location and one or more of the locations of the set of locations. The receiver module 210 can receive the desired location from the user device 130. For example, the user 132 can interact with a user interface or a set of user interface elements of the user device 130 to indicate a desired location or an event corresponding to a desired location and a time. The receiver module 210 can receive the desired location via the network 150 and the communication module 260.

In some embodiments, the desired location can include a set of location characteristics. For example, location characteristics can include a geographic location (e.g., latitude and longitude coordinates, cross streets, map coordinates, map grid indications), an address, a type of location (e.g., office building, theater, restaurant), identification data (e.g., name of a business at the location, type of business at the location, persons associated with the location, events associated with the location), or other characteristics capable of describing or identifying a location, or enabling comparison among two or more locations. In some instances, the set of location characteristics can be stored in a database accessible to the server machine 110, such that the set of location characteristics can be identified and accessed when a correspondence is sought between the desired location and one or more locations of the set of locations.

In operation 350, the recommendation module 230 generates a recommendation of one or more recommended portable articles from the set of portable articles based on the portable article profile for the desired location. The recommendation can be generated by a comparison of the desired location to the set of locations. For example, where the recommendation module 230 determines that the desired location is a location included within the set of locations, the recommendation module 230 can generate the recommendation by determining and accessing the portable article profile associated with the desired location to retrieve the one or more portable articles included in the portable article profile. The recommendation module 230 can then include all or a subset of the one or more portable articles included in the portable article profile.

Where the desired location is not included within the set of locations, the recommendation module 230 can compare the desired location with locations of the set of locations to determine a correspondence among the desired location and one or more locations of the set of locations. For example, the recommendation module 230 can compare location characteristics for each location of the set of locations with location characteristics representative of the desired location. The recommendation module 230 can determine the correspondence by matching one or more of the location characteristics of the desired location and the set of locations. For example, location characteristics can be said to match when they are shared between the desired location and one of the set of locations. In some instances, location characteristics can match when a first location characteristic of the desired location correlates to a second location characteristic of a location of the set of locations without being shared. Location characteristics can be determined to correlate where the location characteristics are related, such as by a category relationship, a hierarchical relationship, or another determined relationship.

Whether the desired location is included or not included in the set of locations, the recommendation module 230 can determine which of the one or more portable articles to include in the recommendation based on the receiver module 210 receiving one or more user interface selections. The one or more user interface selections can be representative of selections for characteristics of the one or more portable articles to include within the recommendation. For example, the user 132 can select a type of portable article (e.g., clothing, bedding, camping gear), a time, an event (e.g., a dinner, a play, a concert), and other characteristics relating to either the location or to portable articles which may be associated with the location. The recommendation module 230, receiving the user selections, can include one or more portable articles in the recommendation based on characteristics of the portable article corresponding to the one or more user selections.

In operation 360, the presentation module 250 causes presentation of the recommendation on a user interface of a user device. For example, the presentation module 250 can receive the one or more recommended portable articles from the recommendation module 230. The presentation module 250 can generate one or more user interface screens or user interface elements and include a graphical representation, a network link, a written description, or another representation of the one or more recommended portable articles. The presentation module 250 can then cause presentation of the recommendation on the user interface by transmitting the representation of the one or more recommended portable articles to the user device 130, causing the user device 130 to display the recommendation on a screen of the user device 130.

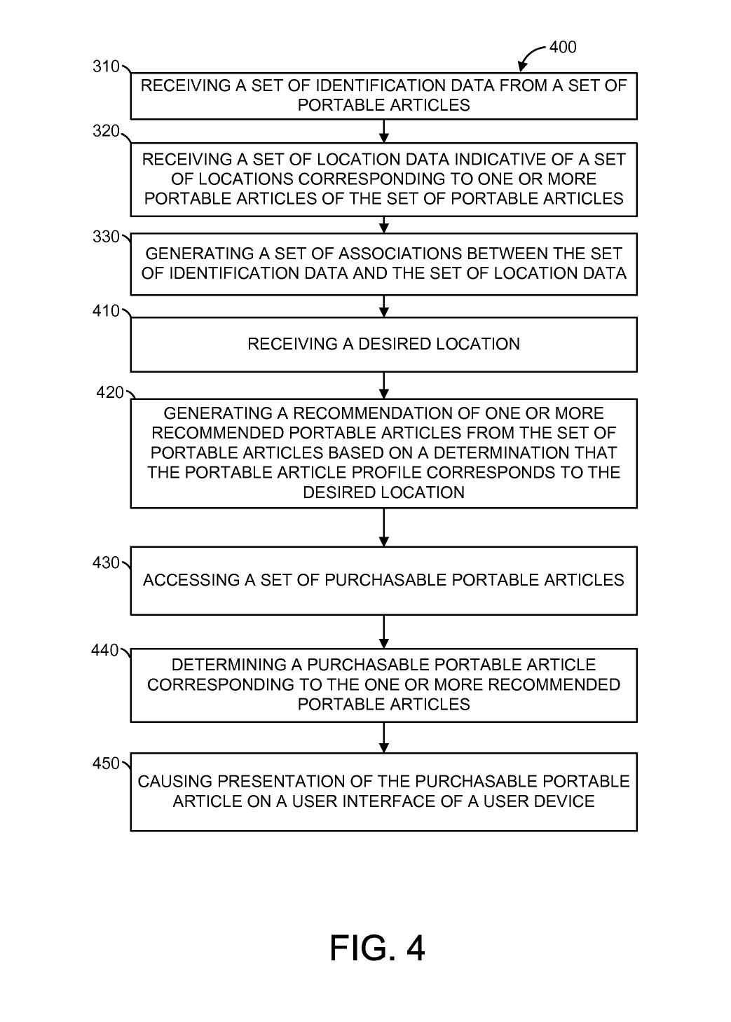

FIG. 4 is a flowchart illustrating operations of the server machine 110 in performing a method 400 of determining a purchasable portable article corresponding to a recommendation of one or more portable articles suitable for a desired location. Operations in the method 400 may be performed by the server machine 110, using modules described above with respect to FIG. 2. As shown in FIG. 4, the method 400 can include one or more of the operations of the method 300.

In the method 400, the server machine 110 can perform operations 310, 320, and 330 to populate a database (e.g., the database 125) with the set of identification data, the set of location data, and the set of associations representative of the set of portable article profiles. In operation 410, the receiver module 210 receives a desired location. As discussed with reference to the operation 340, the desired location can be included within the set of locations or may be a location not included in the set of locations. The operation 410 can be performed similarly to the operation 340.

In operation 420, the recommendation module 230 generates a recommendation of one or more recommended portable articles from the set of portable articles based on a determination that the portable article profile corresponds to the desired location. Similarly to the embodiments discussed with respect to operation 350, the recommendation module 230 can select one or more recommended portable articles from a portable article profile for the desired location or from a portable article profile linked to a location determined to correspond to the desired location. The recommendation module 230 can then pass the one or more recommended portable articles, or data representative thereof, to the purchase module 240.

In operation 430, the purchase module 240 can receive the one or more recommended portable articles from the recommendation module 230. In some instances the purchase module 240 can receive the one or more recommended portable articles through the communication module 260. Once the one or more recommended portable articles have been received, the purchase module 240 can access a set of purchasable portable articles. The set of purchasable portable articles can be portable articles offered for purchase (e.g., sale, auction, or barter) over the network 150, offered for purchase at one or more physical locations, or otherwise purchasable and available for access by the purchase module 240. For example, the set of purchasable portable articles can be stored on the database 125 of the publication system 120. In these embodiments, the publication system 120 can form all or a part of a retailer operating at least in part on the network 150 (e.g., a website for an online retailer, an auction website, a shopping aggregation website). In some instances, the purchase module 240 can act as a shopping aggregation system accessing the set of purchasable portable articles via the network 150 by communicating with a plurality of third party systems.

In operation 440, the purchase module 240 determines a purchasable portable article corresponding to the one or more recommended portable articles. The purchase module 240 can evaluate the set of purchasable portable articles, including one or more purchasable portable article characteristics associated with each purchasable portable article, in order to determine which of the set of purchasable portable articles correspond to the one or more recommended portable articles. For example, data representative of each purchasable portable article of the set of purchasable portable articles can include data relating to characteristics of the purchasable portable article. In some instances, the characteristics of the set of purchasable portable articles can include data similar to the identification data used to identify the portable articles of the set of portable articles.

In evaluating the correspondence, the purchase module 240 can compare the identification data of the set of portable articles and the one or more recommended portable articles in order to determine one or more correspondences or similarities among one or more categories, elements, characteristics, fields, or other portions of data of the purchasable portable article and the one or more recommended portable articles which are related (e.g., matching, related by categorical or hierarchical relationship). In some embodiments, the purchase module 240 can determine the correspondence based on a determination that a relation value representative of a relation between the purchasable portable article and the one or more recommended portable articles exceeds a predetermined threshold. For example, the purchase module 240 can increment the relation value upon determining a match or relationship between characteristics or identification data of the purchasable portable article and the one or more recommended portable articles. When the purchase module 240 determines that the relation value exceeds the predetermined threshold, the purchase module 240 may identify the correspondence between the purchasable portable article and the one or more recommended portable articles.

In operation 450, the presentation module 250 causes presentation of the purchasable portable article on the user interface of the user device 130. Upon determination of the correspondence among the purchasable portable article and the one or more recommended portable articles, the purchase module 240 can pass data indicative of the purchasable portable article to the presentation module 250 for presentation on the user interface. Operation 450 can be performed similarly to operation 360, by transmitting data representative of the purchasable portable article to the user device 130 for presentation or otherwise causing presentation of the purchasable portable article on the user interface of the user device 130.

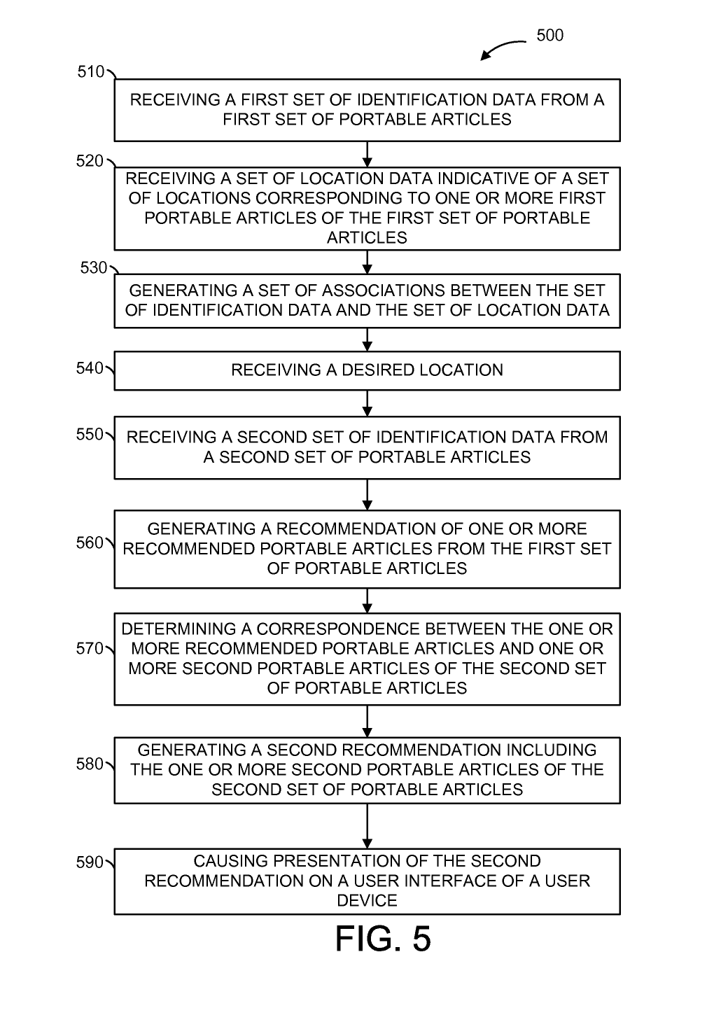

FIG. 5 is a flowchart illustrating operations of the server machine 110 in performing a method 500 of generating a recommendation of one or more portable articles suitable for a desired location from a set of portable articles in possession of the user 132, based on a portable article profile. Operations in the method 500 may be performed by the server machine 110, using modules described above with respect to FIG. 2. As shown in FIG. 5, the method 500 can include one or more operations similar to the operations of the method 300.

In operation 510, the receiver module 210 receives a first set of identification data from a first set of portable articles. Operation 510 can be performed similarly to the operation 310 described above. The identification data can be received directly from identification transceivers associated, attached, included within, or proximate to a portable article. In some instances the identification data can be received via a communications device serving as a transmission intermediary between the identification transceiver and the receiver module 210. The receiver module 210 can receive the identification data, from the identification transceiver or a communications device, via the communication module 260 and the network 150.

In operation 520, the receiver module 210 receives a set of location data indicative of a set of locations corresponding to one or more first portable articles of the first set of portable articles. Operation 520 can be performed similarly to the operation 320 described with respect to the method 300. As noted above, location data of the set of location data can be places, events, geographic coordinates, GPS coordinates, map grid coordinates, addresses, or any other information capable of identifying a location or capable of being used to identify a location.

In operation 530, the generation module 220 generates a set of associations between the set of identification data and the set of location data. In some instances, operation 530 can be performed similarly to operation 330 described above. The set of associations can represent portable article profiles linked to each location of the set of location data. Each of the portable article profiles can include one or more portable articles that have been worn, carried, brought, or otherwise used proximate to the location with which the portable article is associated.

In operation 540, the receiver module 210 receives a desired location. Operation 540 can be performed similarly to operation 340 of the method 300. As described above, the receiver module 210 can receive the desired location from the user device 130. The desired location can include an address, map coordinates, GPS coordinates, an event, a venue, a title, or any other identifying information representing the desired location. The desired location can also include information representative of an event. The event can include a predetermined location. When receiving the desired location as represented by information for the event, the receiver module 210, the generation module 220, the recommendation module 230, or any other suitable element or mechanism can determine the desired location associated with the event and pass the desired location to the receiver module 210.

In operation 550, the receiver module 210 receives a second set of identification data from a second set of portable articles. In some embodiments, operation 550 can be performed similarly to operation 310 of the method 300 or operation 510, described above. However, the second set of portable articles can be a set of portable articles associated with the user 132. In these instances, the second set of portable articles can be representative of articles of clothing, clothing accessories, pieces of equipment, and the like which the user 132 owns. The identification data from the second set of portable articles can be received by the receiver module 210 from the user device 130 or another suitable communications device. The identification data for the second set of portable articles can be received by the receiver module 210 automatically, such as via identification transceivers associated with portable articles of the second set of portable articles. In some embodiments, the receiver module 210 can receive the identification data manually. For example, the user 132 can interact with selectable user interface elements on the user interface of the user device 130 to select characteristics or other identification data for one or more of the portable articles of the second set of portable articles. Once suitable identification data has been selected, the user 132 can then select a user interface element configured cause transmission of the identification data to the receiver module 210.

In some instances, where the second set of portable articles are received from a specified user (e.g., the user 132), the method 500 can include an operation in which the generation module 220 generates an association between the second set of portable articles and the specified user. The association can represent a user article profile indicative of portable articles associated with (e.g., owned or possessed by) the specified user. In some instances, the user article profile can include a set of location data associated with the second set of portable articles indicating locations to which the specified user has transported one or more portable articles of the second set of portable articles. Further, in some embodiments, the user article profile can include times and time durations associated with the set of location data and the second set of portable articles, indicating times, dates, and time durations during which portable articles of the second set of portable articles were proximate to one or more locations of the set of locations.

In operation 560, the recommendation module 230 generates a recommendation of one or more recommended portable articles from the first set of portable articles based on the portable article profile determined to correspond to the desired location. Operation 560 can be performed similarly to operation 350. The recommendation can be generated by determining one or more portable articles from the portable article profile associated with the desired location, where the desired location is included in the set of locations. In some example embodiments, the recommendation can be generated by determining the portable article profile for a location determined to be similar or corresponding to the desired location and retrieving the one or more portable articles from the portable article profile.

In operation 570, the recommendation module 230 determines a correspondence between the one or more recommended portable articles and one or more second portable articles of the second set of portable articles. The operation 570 can be performed similarly to the operation 440. For example, the correspondence can be based on an evaluation and comparison of identification data or characteristics associated with each of the one or more recommended portable articles and the one or more second portable articles of the second set of portable articles.

In operation 580, the recommendation module 230 generates a second recommendation including the one or more second portable articles of the second set of portable articles. The second recommendation can be generated similarly to the recommendation of the one or more recommended portable articles. The one or more second portable articles of the second recommendation can be indicative of portable articles (e.g., articles of clothing) owned by or accessible to the user 132 which are suitable to the desired location, based on a comparison of the set of second portable articles (e.g., the user's 132 wardrobe) and the set of portable articles (e.g., articles of clothing worn by other users).

In operation 590, the presentation module 250 causes presentation of the second recommendation on the user interface of the user device 130. Upon generating the second recommendation, the recommendation module 230 can pass the second recommendation to the presentation module 250, for example via the communication module 260. Operation 590 can be performed similarly to operations 360 and 450.

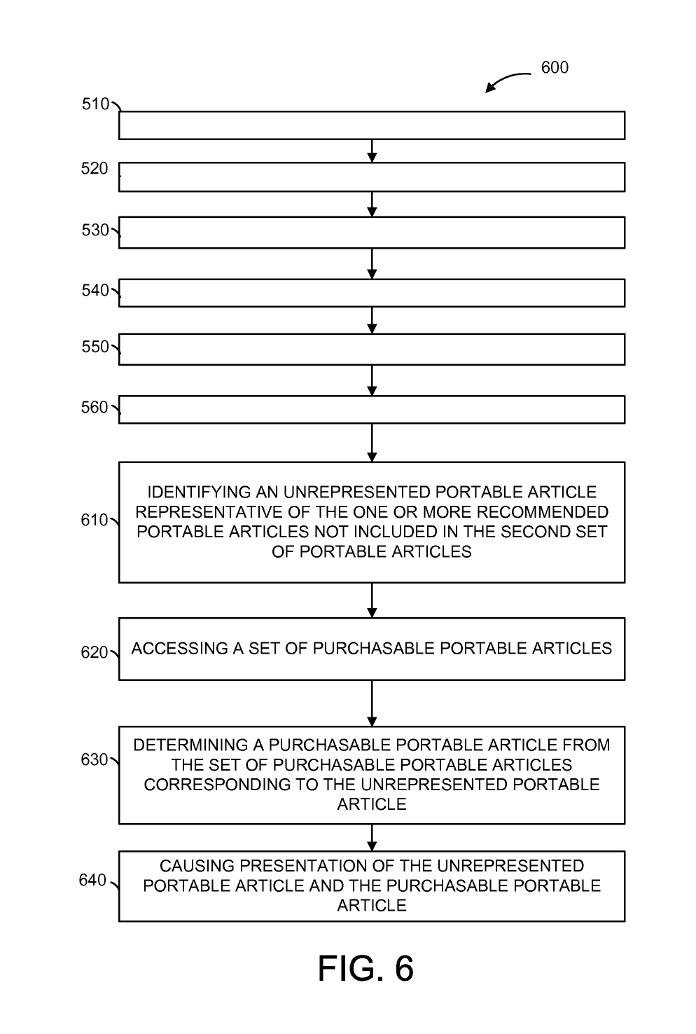

FIG. 6 is a flowchart illustrating operations of the server machine 110 in performing a method 600 of determining a purchasable portable article suitable for a desired location, corresponding to a recommended portable article not included in a set of portable articles in possession of the user 132, based on a portable article profile. Operations in the method 600 may be performed by the server machine 110, using modules described above with respect to FIG. 2. As shown in FIG. 6, the method 600 can include one or more of the operations of the method 500. For example, the method 600 can include operations 510-560.

In operation 610, the recommendation module 230 identifies an unrepresented portable article representative of the one or more recommended portable articles not included in the second set of portable articles. The recommendation module 230 can identify the unrepresented portable article similarly to identifying the correspondence of portable articles in operations 440 and 570. For example, the recommendation module 230 can determine that none of the second set of portable articles corresponds to the one or more recommended portable articles (e.g., the relation value for portable articles of the second set of portable articles and the one or more recommended portable articles fails to exceed the predetermined threshold). After determining that none of the portable articles of the second set of portables articles corresponds to the one or more recommended portable articles, the recommendation module 230 can pass data indicative of the one or more recommended portable articles and data indicative of the lack of correspondence to the purchase module 240.

In operation 620, the purchase module 240 accesses a set of purchasable portable articles. The operation 620 can be performed similarly to the operation 430. For example, the purchase module 240 can receive the one or more recommended portable articles and access the set of purchasable portable articles over the network 150 by accessing the database 125 of the publication system 120 or any other database containing purchasable portable articles.

In operation 630, the purchase module 240 determines a purchasable portable article from the set of purchasable portable articles corresponding to the unrepresented portable article. The purchase module 240 can determine that the purchasable portable article corresponds to the unrepresented portable article (e.g., the one or more recommended portable articles) by comparing identification data and characteristic data of the set of purchasable portable articles with the identification data and characteristic data of the one or more recommended portable articles. For example, the operation 630 can be performed similarly to the operation 440.

In operation 640, the presentation module 250 can cause presentation of the unrepresented portable article. In some instances, the presentation module 250 can cause presentation of the purchasable portable article corresponding to the unrepresented portable article independently or in addition to causing presentation of the unrepresented portable article. The operation 640 can be performed similarly to the operations 360, 450, and 590. For example, the presentation module 250 can cause presentation of the unrepresented portable article and the purchasable portable article by transmitting data representative of the unrepresented portable article and the purchasable portable article to the user device 130. In some embodiments, the presentation module 250 can cause presentation on the user interface of the user device 130 by causing the user device 130 to generate or display a web page or one or more user interface elements including data representative of the unrepresented portable article and the purchasable portable article.

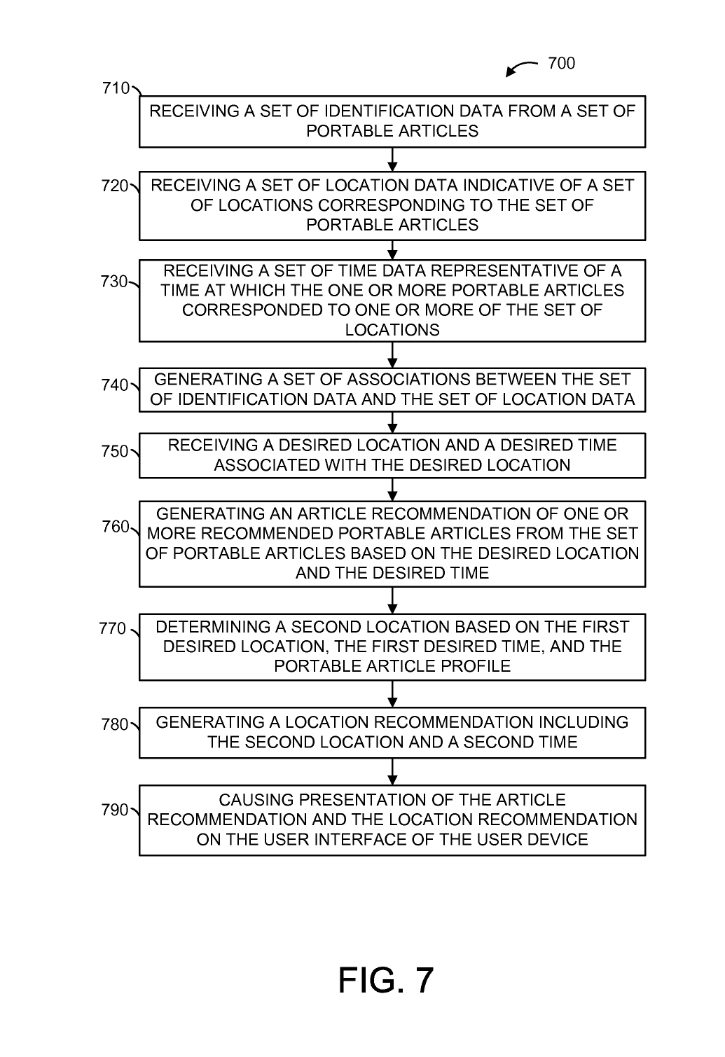

FIG. 7 is a flowchart illustrating operations of the server machine 110 in performing a method 700 of generating recommendations of one or more portable articles suitable for a desired location, based on the desired location, a desired time, and a portable article profile. Operations in the method 700 may be performed by the server machine 110, using modules described above with respect to FIG. 2. As shown in FIG. 7, the method 700 can include one or more operations of the method 300.

In operation 710, the receiver module 210 receives a set of identification data from a set of portable articles. For example, the receiver module 210 can receive the set of identification data from identification transceivers connected to each portable article of the set of portable articles. In some instances, the operation 710 can be performed similarly to the operation 310 of the method 300 or to the operation 510 of the method 500. As such, in some instances, the set of identification data can be received indirectly from the set of portable articles, such as through communications devices acting as an intermediary to transmit the identification data from the identification transceivers to the receiver module 210.

In operation 720, the receiver module 210 receives a set of location data indicative of a set of locations corresponding to one or more portable articles of the set of portable articles. The operation 720 can be performed similarly to the operations 320 or 520. The receiver module 210 can receive the set of location data automatically (e.g., as a result of the one or more portable articles arriving at the location) or manually (e.g., as a result of a user entering the location data and identification data for the one or more portable articles into a user device for transmission to the receiver module 210).

In operation 730, the receiver module 210 receives a set of time data representative of a time at which the one or more portable articles corresponded to one or more of the set of locations. For example, the time data can indicate a time at which the one or more portable articles were proximate to the location and the duration of the proximity. In some instances, the set of time data can be received by the receiver module 210 by a user manually entering time data for the one or more portable articles. The time data can be determined by the server machine 110 based on the receiver module 210 receiving the identification data of the one or more portable articles and the location data associated with the one or more portable articles. For example, the receiver module 210 can receive the identification data and the location data when the one or more portable articles arrive proximate to the location. The receiver module 210 can determine the time by receiving an indication from a clock (e.g., a system clock associated with the server machine 110) associated with the receiver module 210. The receiver module 210 can also receive second time data indicative of the one or more portable articles being removed from the location and determine a duration of time during which the one or more portable articles were located proximate to the location. In some embodiments, the receiver module 210 can receive time data from a user associated with the one or more portable articles by the user entering the time data into a user interface of a user device and transmitting the time data to the receiver module 210.

In operation 740, the generation module 220 generates a set of associations between the set of identification data and the set of location data. In some instances, the set of associations can incorporate the set of time data. For example, an association of the set of associations can form a portion of a portable article profile associating one or more portable articles of the set of portable articles with a location of the set of locations for a time or time duration specified by the set of time data. In some instances, one or more portable articles can be associated with a location for a first specified time of day (e.g., a first dress code for a restaurant during hours of operation for lunch between 10:00 a.m. and 3:00 p.m.) while other portable articles can be associated with the location for a second specified time of day (e.g., a second dress code for the restaurant during hours of operation for dinner between 5:00 p.m. and 10:00 p.m.). The generation module 220 can generate the associations in a manner similar to that outlined with respect to operation 330.

In operation 750, the receiver module 210 receives a desired location and a desired time associated with the desired location. As with operation 340 or operation 540, the desired location can be included among the set of locations or can be outside of the set of locations. The desired time can be one or more of a desired time of day, a date, a time duration, combinations thereof, or any suitable time metric. In some embodiments, the receiver module 210 can receive data representing an event, with the receiver module 210 determining a desired location and a desired time associated with the event. For example, the receiver module 210 can receive data representative of a concert. Upon receiving the event data, the receiver module 210 can determine the desired location and the desired time from a set of event data accessible to the receiver module 210. In some embodiments, the set of event data can be stored in a database associated with the server machine 110. However, in some instances the set of event data can be stored on one or more third party servers (e.g., a webserver hosting a website with information relating to the event or the venue at which the event is held). The receiver module 210 can access the set of event data directly or can access the set of event data via one or more of the generation module 220, the recommendation module 230, the purchase module 240, and the communication module 260.

In operation 760, the recommendation module 230 generates a recommendation of one or more recommended portable articles from the set of portable articles based on the portable article profile for the desired location and the desired time. The recommendation module 230 can perform operation 760 similarly to the operations 350, 420, 560, or 580. Where the portable article profile for the desired location, or corresponding to the desired location, contains a set of time data delimiting one or more portable articles within the portable article profile by time, the recommendation module 230 can include a determination that the one or more recommended portable articles fall within the time limitation for the portable article profile.

For example, where a desired location is associated with casual clothing at a first time and formal clothing at a second time, the recommendation module 230 can base the one or more recommended portable articles on a comparison of the desired time to the first time and the second time. When the desired time falls within the first time, the one or more recommended portable articles could be one or more casual clothing items. When the desired time falls within the first time but is determined to extend into the second time (e.g., based on a desired time duration within the desired time), the recommendation module 230 can provide recommendations for the one or more portable articles for the first time or for the second time, or recommendations for one or more portable articles which may be determined to be suitable for both the first and second times. In some embodiments, the recommendation module 230 can provide a first set of one or more recommended portable articles for the first time and an indication of the time for which the first set of one or more recommended portable articles are recommended. The recommendation module 230 can also provide a second set of one or more recommended portable articles, the addition of which may cause the first set of one or more recommended portable articles to be suitable for the second time. For example, the first set of one or more recommended portable articles can include a shirt and pants suitable for the first time, and the second set of one or more recommended portable articles can include a jacket which can cause the shirt and pants to be suitable for the second time.

In some embodiments, the desired location can be a first desired location, the desired time can be a first desired time, and the recommendation can be an article recommendation. In these instances, the method 700 can include operation 770, in which the recommendation module 230 determines a second location based on the first desired location, the first desired time, and the portable article profile corresponding to the first desired location and the first desired time. For example, the user 132 can input a first event including a location of a venue and a time for a play being performed at the venue. The recommendation module 230 can determine that a second event (e.g., a dinner or a drink) is related to the first event. The recommendation module 230 can determine the relation between the first event and the second event through identification data of the first desired location and the first desired time within the portable article profile for that location, previous actions of the user 132, previous actions of other users, proximity between the first location and the second location, or any other suitable method.

In operation 780, in response to determining the second location, the recommendation module 230 can generate a location recommendation including the second location and a second time. The location recommendation can be generated by including data indicative of the second location, the second time, and whether the one or more recommended portable articles are suitable for the second location and the second time.

In operation 790, the presentation module 250 causes presentation of the article recommendation and the location recommendation on the user interface of the user device 130. The presentation of the article recommendation and the location recommendation can be performed similarly to the operations 360, 450, 590, and 640.

According to various example embodiments, one or more of the methodologies described herein may facilitate knowledge of what portable articles to bring to certain locations or events, or to locations or events at certain times. For example, these methodologies can facilitate a user knowing what types of clothing, styles, brands, colors, etc. people wear to a particular location. These methodologies can also facilitate bundling of activities for a user, such as bundling of locations and events, enabling a user to plan an evening with appropriate attire and accoutrements throughout the evening. One or more of the methodologies described herein may obviate a need for certain efforts or resources that otherwise would be involved in finding events to attend and determining appropriate dress or accoutrements for the events or locations to be attended. Efforts expended by a user 132 or 142 in deciding on appropriate clothing and accoutrements for desired locations or recommended locations and events may be similarly reduced by one or more of the methodologies described herein. Computing resources used by one or more machines, databases 125, or devices (e.g., within the network environment 100) associated with the efforts of users 132 or 142 may similarly be reduced. Examples of such computing resources include processor cycles, network traffic, memory usage, data storage capacity, power consumption, and cooling capacity.

FIG. 8 is a block diagram illustrating components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be communicatively coupled (e.g., networked) to other machines. In a networked deployment, the machine 800 may operate in the capacity of a server machine 110 or a client machine in a server-client network environment, or as a peer machine in a distributed (e.g., peer-to-peer) network environment 100. The machine 800 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines 800 that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or another pointing instrument), a storage unit 816, an audio signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the static memory, within the processor 802 (e.g., within the processor's 802 cache memory), or combinations thereof, before or during execution thereof by the machine 800. Accordingly, the main memory 804 and the processor 802 may be considered machine-readable media 822 (e.g., tangible and non-transitory machine-readable media 822). The instructions 824 may be transmitted or received over the network 826 (e.g., network 150) via the network interface device 820. For example, the network interface device 820 may communicate the instructions 824 using any one or more transfer protocols (e.g., hypertext transfer protocol (HTTP)).

In some example embodiments, the machine 800 may be a portable computing device, such as a smartphone or tablet computer, and may have one or more additional input components 828 (e.g., sensors or gauges). Examples of such input components 828 include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 828 may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown, in an example embodiment, to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

FIG. 9 is a block diagram illustrating a mobile device 900, according to some example embodiments. For example, the mobile device 900 may be an implementation of the user device 130 or 140. In some embodiments, the mobile device 900, in communication with the server machine 110, can perform some of the methodologies described herein, and can provide input from the user 132 or 142 to the server machine 110. The mobile device 900 can include a processor 902. The processor 902 can be any of a variety of different types of commercially available processors suitable for mobile devices 900 (for example, an XScale architecture microprocessor, a microprocessor without interlocked pipeline stages (MIPS) architecture processor, or another type of processor). A memory 904, such as a random access memory (RAM), a flash memory, or another type of memory, is typically accessible to the processor 902. The memory 904 can be adapted to store an operating system (OS) 906, as well as application 908 (e.g., application programs), such as a mobile location enabled application that can provide location based services to a user 132 or 142. The processor 902 can be coupled, either directly or via appropriate intermediary hardware, to a display 910 and to one or more input/output (I/O) devices 912, such as a keypad, a touch panel sensor, a microphone, and the like. Similarly, in some example embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

The mobile device 900 can be configured to perform any one or more of the methodologies discussed herein. For example, the memory 904 of the mobile device 900 may include instructions 824 comprising one or more of the receiver module 210, the generation module 220, the recommendation module 230, the purchase module 240, the presentation module 250, and the communication module 260. The modules can configure the processor 902 of the mobile device 900 to perform one or more of the operations outlined above with respect to each module. In some embodiments, the mobile device 900 and the machine 800 can each store at least a portion of the modules discussed above and cooperate to perform the methods described above, as will be explained in more detail below.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations, and may be configured or arranged in a certain physical manner. In various example embodiments, one or more computer systems (e.g., a standalone computer system, a client computer system, or a server computer system) or one or more hardware modules of a computer system (e.g., a processor 902 or a group of processors 902) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 902 or other programmable processor 902. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 902 configured by software to become a special-purpose processor, the general-purpose processor 902 may be configured as respectively different special-purpose processors (e.g., comprising different hardware modules) at different times. Software (e.g., a software module) may accordingly configure one or more processors 902, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 808) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions described herein. As used herein, “processor-implemented module” refers to a hardware module implemented using one or more processors 902.

Similarly, the methods described herein may be at least partially processor-implemented, a processor 902 being an example of hardware. For example, at least some of the operations of a method may be performed by one or more processors 902 or processor-implemented modules. As used herein, “processor-implemented module” refers to a hardware module in which the hardware includes one or more processors 902. Moreover, the one or more processors may also operate to support performance of the relevant operations in a “cloud computing” environment or as a “software as a service” (SaaS). For example, at least some of the operations may be performed by a group of computers (as examples of machines 800 including processors 902), with these operations being accessible via a network 150 or 826 (e.g., the Internet) and via one or more appropriate interfaces (e.g., an API).

The performance of certain operations may be distributed among the one or more processors 802 or 902, not only residing within a single machine 800 or a single mobile device 900, but deployed across a number of machines 800 or a number of mobile devices 900. In some example embodiments, the one or more processors 902 or processor-implemented modules may be located in a single geographic location (e.g., within a home environment, an office environment, or a server farm). In other example embodiments, the one or more processors 902 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 800. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
a processor implemented receiver module configured to receive a set of identification data from a set of portable articles, a set of location data indicative of a set of locations corresponding to one or more portable articles of the set of portable articles, and a desired location;
a generation module configured to generate a set of associations between the set of identification data and the set of location data, an association of the set of associations being a portable article profile associating one or more portable articles of the set of portable articles with a location of the set of locations;
a recommendation module configured to generate a recommendation of one or more recommended portable articles from the set of portable articles based on the portable article profile for the desired location; and
a presentation module configured to cause presentation of data relating to the recommendation on a user interface of a user device.

2. The system of claim 1, wherein the receiver module is further configured to receive a set of time data representative of a time at which the one or more portable articles were proximate to the location of the portable article profile and a time duration during which the one or more portable articles were located at the location.

3. The system of claim 1, further comprising a purchase module configured to access a set of purchasable portable articles and determine a purchasable portable article from the set of purchasable portable articles corresponding to the one or more recommended portable articles, and wherein the presentation module is further configured to cause presentation of the purchasable portable article on the user interface of the user device.

4. The system of claim 1, wherein the desired location is a first desired location and the recommendation is an article recommendation, the receiver module is further configured to receive a desired time associated with the first desired location, the recommendation module is further configured to determine a second location based on the first desired location, the desired time, and the portable article profile and generate a location recommendation including the second location and a second time, and the presentation module is further configured to cause presentation of the article recommendation and the location recommendation on the user interface of the user device.

5. A method comprising:
receiving a set of identification data from a set of portable articles, the identification data received from an identification transceiver connected to a portable article of the set of portable articles;
receiving a set of location data indicative of a set of locations corresponding to one or more portable articles of the set of portable articles;
generating a set of associations between the set of identification data and the set of location data, an association of the set of associations being a portable article profile associating one or more portable articles of the set of portable articles with a location of the set of locations;
receiving a desired location included in the set of locations;
generating a recommendation of one or more recommended portable articles from the set of portable articles based on the portable article profile for the desired location; and
causing presentation of the recommendation on a user interface of a user device.

6. The method of claim 5, wherein the set of portable articles is chosen from a group consisting of a set of clothing, a set of clothing accessories, a set of fashion accessories, and a set of portable equipment.

7. The method of claim 5, wherein the identification data is received from a communications device detecting a proximity of the identification transceiver and the identification data associated with the identification transceiver.

8. The method of claim 5, wherein the location data corresponding to a portable article of the set of portable articles is received from a communication device proximate to the portable article.

9. The method of claim 5, wherein the location data corresponding to a portable article of the set of portable articles is received from an identification transceiver connected to the portable article.

10. The method of claim 5, further comprising:
determining the portable article profile associated with the desired location.

11. The method of claim 5, further comprising:
accessing a set of purchasable portable articles;
determining a purchasable portable article corresponding to the one or more recommended portable articles; and
causing presentation of the purchasable portable article on the user interface of the user device.

12. The method of claim 5, wherein the set of portable articles is a first set of portable articles, and further comprising:
receiving identification data from a second set of portable articles;
determining a correspondence between the one or more recommended portable articles and one or more second portable articles of the second set of portable articles;
generating a second recommendation including the one or more second portable articles; and
causing presentation of the second recommendation on the user interface of the user device.

13. The method of claim 5, wherein the set of portable articles is a first set of portable articles and further comprising:
receiving identification data from a second set of portable articles;
determining a correspondence between the second set of portable articles and the one or more recommended portable articles;
identifying an unrepresented portable article representative of the one or more recommended portable articles not included in the second set of portable articles; and
causing presentation of the unrepresented portable article.

14. The method of claim 13, wherein causing presentation of the unrepresented portable article further comprises:
accessing a set of purchasable portable articles;
determining a purchasable portable article from the set of purchasable portable articles corresponding to the unrepresented portable article; and
causing presentation of the purchasable portable article on the user interface of the user device.

15. The method of claim 5, further comprising:
receiving a set of time data representative of a time at which the one or more portable articles were proximate to the location of the portable article profile and a time duration during which the one or more portable articles were located at the location; and
including the set of time data in the portable article profile.

16. The method of claim 15, further comprising:
receiving a desired time associated with the desired location; and
generating the recommendation of the one or more recommended portable articles from the set of portable articles based on a portable article profile corresponding to the desired location and the desired time.

17. The method of claim 5, wherein the desired location is a first desired location and the recommendation is an article recommendation, and further comprising:
receiving a desired time associated with the desired location;
generating the article recommendation of the one or more recommended portable articles from the set of portable articles based on a portable article profile corresponding to the desired location and the desired time;
determining a second location based on the first desired location, the desired time, and the portable article profile corresponding to the first desired location and the desired time;
generating a location recommendation including the second location and a second time; and
causing presentation of the article recommendation and the location recommendation on the user interface of the user device.

18. A non-transitory machine-readable storage medium comprising processor-executable instructions that, when executed by a processor of a machine, cause the machine to perform operations comprising:
receiving a set of identification data from a set of portable articles;
receiving a set of location data indicative of a set of locations corresponding to one or more portable articles of the set of portable articles;
generating a set of associations between the set of identification data and the set of location data, an association of the set of associations being a portable article profile associating one or more portable articles of the set of portable articles with a location of the set of locations;
receiving a desired location of the set of locations;
generating a recommendation of one or more recommended portable articles from the set of portable articles based on the portable article profile for the desired location; and
causing presentation of the recommendation on a user interface of a user device.

19. The non-transitory machine-readable storage medium of claim 18, wherein the operations further comprise:
accessing a set of purchasable portable articles;
determining a purchasable portable article corresponding to the one or more recommended portable articles; and
causing presentation of the purchasable portable article on the user interface of the user device.

20. The non-transitory machine-readable storage medium of claim 18, wherein the operations further comprise:
receiving a set of time data representative of a time at which the one or more portable articles were proximate to the location of the portable article profile and a time duration during which the one or more portable articles were located at the location; and
including the set of time data in the portable article profile.
